(19) United States
(12) Patent Application Publication
(10) Pub. No.: US 2015/0313212 A1
(43) Pub. Date: Nov. 5, 2015

(54) Compositions and Methods for Improving the Compatibility of Water Soluble Herbicides Salts and Concentrated Fertilizer

(71) Applicant: AKZO NOBEL CHEMICALS INTERNATIONAL B.V., Amersfoort (NL)

(72) Inventors: Mark Alexander, Fort Worth, TX (US); Klin Aloysius Rodrigues, Signal Mountain, TN (US); Anne Austin, Signal Mountain, TN (US)

(73) Assignee: Akzo Nobel Chemicals International B.V., Amersfoort (NL)

(21) Appl. No.: 14/650,642

(22) PCT Filed: Dec. 17, 2013
(86) PCT No.: PCT/EP2013/076803

§ 371 Date: Jun. 9, 2015

Related U.S. Application Data
(60) Provisional application No. 61/739,081, filed on Dec. 19, 2012.

(51) Int. Cl. A01N 25/02; C05C 1/00; A01N 37/40; C05G 3/02; A01N 39/04

(52) U.S. Cl. CPC A01N 25/02; C05G 3/02; A01N 39/04; A01N 37/40; C05C 1/00

(57) ABSTRACT

Methods and compositions for improving the compatibility of aqueous herbicide solutions containing at least one of a water soluble salt of a herbicidal active and high concentrations of fertilizer, such as ammonium sulfate, by adding certain polymeric crystallization inhibitors are provided.

### FIELD OF THE INVENTION

The present invention generally relates to a novel class of polymeric crystallization inhibitors useful in improving the compatibility of aqueous herbicide solutions containing a water soluble active ingredient, such as 2,4-D DMA (4-Dichlorophenoxyacetic acid, dimethylamine salt) and fertilizer.

### BACKGROUND OF THE INVENTION

Aqueous concentrate formulations of pesticidal and plant growth modifying chemicals are widely used in agricultural, industrial, recreational, and residential areas worldwide. The active ingredients of such concentrates frequently contain acid functional groups such as carboxylic or phosphonic acids, more commonly in the form of their water soluble salts. An aqueous concentrate is essentially a solution of an active ingredient in water at relatively high concentration, intended for dilution in water prior to application by spraying or other means. Typically an aqueous concentrate is diluted in about 10 to about 500 times its own volume of water prior to application.

Formulations that contain water soluble pesticidal and plant growth modifying active ingredients, such as 2,4-D DMA, can experience incompatibilities when diluted into fertilizer solutions. The incompatibility manifests itself as the rapid formation of a precipitant. It is well known to the skilled in the art that the formation of the precipitant is mainly due to the limited solubility of 2,4-D (4-Dichlorophenoxyacetic acid) with inorganic ions. That precipitant can block screens in the nozzles of the application equipment which leads to deformed spray patterns. The deformed patterns cause poor leaf coverage during application of the herbicide mixture and can lead to reduced efficacy. The formation of the insoluble precipitant itself can reduce efficacy because the decreased water solubility can reduce the uptake of the herbicide by the weeds. The addition of fertilizers, such as ammonium sulfate, can worsen the incompatibility.

There are currently no satisfactory options in the marketplace that prevent the formation of the precipitant in the above-situation. There are some that minimize the crystal growth so that the pesticide “cocktail” can be applied with minimal to no pattern retardation. It has been seen that synthetic polymers can prevent the formation of a precipitant when water soluble actives are mixed with fertilizers. In more severe cases, the polymers can greatly reduce the precipitant population.

It has been seen that the use of certain polymers in accordance with the invention will prevent or greatly inhibit the formation of a precipitant when water soluble herbicides are mixed with fertilizers.

### SUMMARY OF THE INVENTION

The present invention generally relates to a novel class of polymeric crystallization inhibitors useful in improving the compatibility of aqueous herbicide solutions and fertilizers. The invention also relates to a method of improving the compatibility of aqueous herbicide solutions and fertilizer solutions, wherein such solutions contain one or more inorganic cations selected from the group consisting of NH₄⁺, Na⁺, K⁺, Ca²⁺, Mg²⁺, Fe²⁺, Fe³⁺, Cu²⁺, Mn²⁺ and zn²⁺, which comprises adding to the aqueous herbicide solution one or more polymeric crystallization inhibitors of the invention.

Further, an aqueous herbicide solution of improved compatibility including at least one of a water soluble salt of an aryloxyalkanoic acid, a water soluble salt of a pyridyloxyalkanoic acid, and/or a water soluble salt of glyphosate and >16 wt % of one or more fertilizers, and one or more polymeric crystallization inhibitors of structure I also is provided.

Additionally, a dry herbicide composition including a water soluble salt of 2,4-D and/or a water soluble salt of glyphosate, >16 wt % of one or more fertilizers, and one or more polymeric crystallization inhibitors of structure I also is provided.

### BRIEF DESCRIPTION OF THE DRAWINGS

FIGS. 1 to 12 depict various experimental results.

### DETAILED DESCRIPTION OF THE INVENTION

Aqueous herbicide solutions containing at least one of a water soluble salt of an aryloxyalkanoic acid, a water soluble salt of a pyridyloxyalkanoic acid and a water soluble salt of glyphosate and optionally >16 wt % of one or more fertilizers and methods of creating such solutions are provided. The aqueous herbicide solutions described herein have improved compatibility over previously known aqueous herbicide solutions including the listed components. The aqueous herbicide solutions as described herein contain a polymeric crystallization inhibitor that acts as a compatibilizing agent. The polymeric crystallization inhibitors are especially useful when inorganic or organo ammonium cations are present and provide compatibilization without the need to raise the pH of the solution.

It is known that aqueous solutions of a water soluble salt of an aryloxyalkanoic acid such as salts of 2,4-D can have compatibility issues leading to the formation of precipitated solids under conditions where the acid equivalent (ae) concentration is about 0.3 weight percent or higher, the pH is about 6 or lower, and there is a sufficient concentration of inorganic cations such as, for example, K⁺, Na⁺, Ca²⁺, Mg²⁺, NH₄⁺, Fe²⁺, Fe³⁺ and the like. The exact conditions necessary for the formation of precipitated solids from these solutions of 2,4-D salts will also depend on the temperature and hardness of the water used and the actual composition and concentrations of the components in the solution, such as fertilizer.

The common practice of adding ammonium sulfate to aqueous herbicide spray mixtures containing glyphosate to improve herbicide performance may also lead to compatibility problems. For example, if a herbicide such as 2,4-D dimethyl ammonium (DMA) is present in a spray mixture containing glyphosate to which ammonium sulfate has been added, crystallization of solids can occur if the pH and the 2,4-D concentration are in the ranges described herein.

Methods for improving the compatibility of aqueous herbicide solutions and one or more fertilizers in high concentration, including adding to the aqueous herbicide solution one or more polymeric crystallization inhibitors of Formula I, are provided.

AₓB_{y}C_{z} I

wherein A is

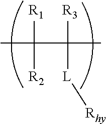

and R₁, R₂, and R₃ are independently H, CH₃, COOH, or CH₂COOH, L is a linking group comprising —C(═O)—O—, —C(══O)—N—, —CH₂—, —O—, —O—C(══O)—, urethane, urea, or a direct bond, and where R_{hy} is a hydrophobic moiety which is linear or branched alkyl, cycloalkyl, aryl, alkaryl or their alkoxylated derivative. In Formula I, x is the mole percent of A and is from about 5 to 80%, z is the mole % of C and is from about 0 to 25%, the rest being y mole % of B, which is from about 1 to 95 mole %. In another embodiment of the polymeric crystallization inhibitor of Formula I, x is from about 10 to 70 mole % of A and z is from about 2 to 20 mole % of C with the rest being y mole % of B. In yet another embodiment, in the polymeric crystallization inhibitor of Formula I, x is from about 15 to 50 mole % of A, z is from about 5 to 15 mole % of C with the rest being y mole % of B; in yet another embodiment y is from about 80 to 35 mole % of B.

R_{hy} is preferably aromatic and is naphthalene, ethoxylated naphthalene, phenyl, ethoxylated phenyl, benzyl or ethoxylated benzyl. The most preferred is phenyl or benzyl. However, R_{hy} can be aliphatic or alkoxylated aliphatic such as a linear or branched C₁ to C₃₂ group. When R_{hy} is linear aliphatic or alkoxylated linear aliphatic it is preferably methyl, ethyl or butyl or their ethoxylated derivatives. R_{hy} is preferably branched aliphatic or alkoxylated branched aliphatic and is preferably 2-ethylhexyl, 2-butyloctyl, 2-hexyldecyl, 2-octyldodecyl, 2-decyltetradecyl, 2-dodecylhexadecyl, isopropyl, isobutyl, tertiary butyl, tertiary octyl or their ethoxylated derivatives. The most preferred is 2-ethylhexyl. If R_{hy} is linear and greater than C₈, then unsaturated hydrophobes are preferred. These unsaturated hydrophobes can be oleyl, coco, soya, erucyl or tallow. The R_{hy} can be incorporated into this dispersant polymer by polymerizing monomers such as but not limited to styrene, benzyl (meth)acrylate, phenyl (meth)acrylate, benzyl ethoxylate (meth)acrylate, phenyl ethoxylate (meth)acrylate, methyl methacrylate, methyl acrylate, 2-ethylhexyl (meth)acrylate, 2-butyloctyl (meth)acrylate, 2-hexyldecyl (meth)acrylate, 2-octyldodecyl (meth)acrylate, 2-decyltetradecyl (meth)acrylate, 2-dodecylhexadecyl (meth)acrylate, isopropyl (meth)acrylate, isobutyl (meth)acrylate, tertiary butyl (meth)acrylate, t-octyl acrylamide, octyl acrylate, lauryl acrylate, stearyl acrylate, behenyl acrylate, 2-ethylhexyl methacrylate, octyl methacrylate, lauryl methacrylate, stearyl methacrylate, behenyl methacrylate, 2-ethylhexyl acrylamide, octyl acrylamide, lauryl acrylamide, stearyl acrylamide, behenyl acrylamide, propyl acrylate, butyl acrylate, pentyl acrylate, hexyl acrylate, vinyl acetate, 1-allyl naphthalene, 2-allyl naphthalene, 1-vinyl naphthalene and 2-vinyl naphthalene.

The polymeric crystallization inhibitors of Formula I are generally prepared by co-polymerizing two monomers including a monomer A and a monomer B, and optionally includes a monomer C, which provide parts A, B, and C as shown in Formula I. The polymeric crystallization inhibitor of Formula I will preferably have 5 to 80 mole % of A and 0 to 25 mole % of C with the rest being B. The polymeric crystallization inhibitor of Formula I will more preferably have 10 to 70 mole % of A and 2 to 20 mole % of C with the rest being B. The polymeric crystallization inhibitor of Formula I will most preferably have 15 to 50 mole % of A and 5 to 15 mole % of C with the rest being B.

Component B of Formula I is derived from polymerizing a monomer B which may be an ethylenically unsaturated carboxylic acid monomer and/or it salts. Useful ethylenically unsaturated carboxylated monomers for preparing the polymeric crystallization inhibitors of Formula I include but are not limited to acrylic acid, methacrylic acid, ethacrylic acid, α-chloro-acrylic acid, α-cyano acrylic acid, β-methyl-acrylic acid (crotonic acid), α-phenyl acrylic acid, β-acryloxy propionic acid, sorbic acid, α-chloro sorbic acid, angelic acid, cinnamic acid, p-chloro cinnamic acid, β-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, muconic acid, 2-acryloxypropionic acid, and maleic acid. Monomers such as maleic anhydride or acrylamide that can form a carboxylic acid moiety are also included. Combinations of ethylenically unsaturated carboxylated monomers can also be used. In one aspect, the ethylenically unsaturated carboxylic acid monomer is acrylic acid, maleic acid, or methacrylic acid.

Optional component C is derived from polymerizing a monomer C which may be an ethylenically unsaturated sulfonic acid monomer or phosphonic acid monomer and/or their salts or any other polymerizable monomer. Examples of ethylenically unsaturated sulfonic acid monomers or phosphonic acid monomers (monomer C) and their salts include, but are not limited to, 2-acrylamido-2-methyl propane sulfonic acid or its sodium salt (AMPS), 2-methacrylamido-2-methyl-1-propanesulphonic acid, 3-methacrylamido-2-hydroxy-propanesulphonic acid, allylsulphonic acid, methallylsulphonic acid, 2-hydroxy-3-(2-propenyloxy)propanesulphonic acid, 2-methyl-2-propene-1-sulphonic acid, 3-sulphopropyl acrylate, 3-sulphopropyl methacrylate, sulphomethylacrylamide, sulphomethylinethacrylamide, sodium styrene sulfonate, sodium 1-allyloxy 2 hydroxy propane sulfonate, allyloxybenzene sulfonic acid, vinyl sulfonic acid, sodium methallyl sulfonate, sulfonated styrene, allyloxybenzene sulfonic acid, vinyl phosphonic acid and others. The polymeric crystallization inhibitors of Formula I may also include inorganic alkaline salts and organic amine salts as derivatives of the corresponding carboxylic, sulfonic and phosphonic acid groups attached to the polymer of Formula I. In certain cases, such as, for example, in the case of improving the compatibility of aqueous solutions containing a water soluble 2,4-D salt, the organic amine salts of the corresponding carboxylic, sulfonic and phosphonic acid groups attached to the polymer of Formula I are useful. The organic amines in the form of their corresponding organo ammonium cations can be selected from, but are not limited to, monomethyl ammonium, isopropyl ammonium, butyl ammonium, dimethyl ammonium, diethyl ammonium, triethyl ammonium, monoethanol ammonium, diethanol ammonium, dimethylethyl ammonium, diethylethanol ammonium, triethanol ammonium, triisopropanol ammonium, tetramethyl ammonium, tetraethyl ammonium and N,N,N-trimethylethanol ammonium (choline), and cations made from dimethylaminopropylamine (DMAPA; N,N-dimethylpropane-1,3-diamine) and diethylenetriamine (DETA; bis(2-aminoethyl)amine), or mixtures thereof.

The polymeric crystallization inhibitors of Formula I can be prepared by processes known in the art such as those disclosed in U.S. Pat. No. 5,650,473 the relevant parts of which are incorporated herein by reference. The polymeric crystallization inhibitor of Formula I can be random, blocky, star shaped or any other architecture. The polymeric crystallization inhibitor of Formula I may have a weight average molecular weight from about 1,000 to about 20,000, and may include derivatives thereof such as, for example, the alkali metal salts such as the sodium carboxylates, the organo ammonium salts or sulfonated derivatives. Suitable polyacrylate co-polymers of Formula I include, for example, Alcosperse® 725, 725-D, 747 and 747-D, and Armak 2092 which are commercially available from Akzo Nobel Surface Chemistry LLC (Chicago, Ill.). Further examples of polymeric crystallization inhibitors of Formula I useful with the compositions and methods disclosed herein include copolymers of benzyl methacrylate and acrylic acid and copolymers of styrene and acrylic acid.

As used herein, the aqueous agricultural solutions of the invention contain a water soluble active and they either contain a fertilizer, or are diluted into and/or mixed with a fertilizer. The term “agrochemical active” means any material that is used in agricultural applications. These include but are not limited to formulations of herbicides, insecticides, fungicides, biocides, molluscicides, algaicides, plant growth regulators, anthelmintics, rodenticides, nematocides, acaricides, amoebicides, protozoacides, crop safeners and adjuvants. Specific examples of actives include:

Herbicides: including triazines such as Atrazine {6-chloro-N-ethyl-N′-(I-methylethyl)-1,3,5-triazine-2,4diamine, and Prometryn {N,N′-bis(1-methylethyl)-6(methylthio)-1,3,5-triazine)-2,4-diamine}, substituted ureas such as Diuron {N′-(3,4-dichlorophenyl)-N,Ndimethylurea}, sulphonyl ureas such as metsulfuron-methyl {2-[[[[(4-methoxy-6-methyl-1,3,5triazin-2-yl)amino]carbonyl]amino]sulfonyl]benzoate}, triasulfuron {2-(2chloroethoxy)-N-[[(4-methoxy-6-methyl-1,3,5-triazin-2-yl)amino]carbonyl]benzenesulfonamide}, tribenuron-methyl{methyl 2-[[[[(4-methoxy-6-methyl-I,3,5triazin-2-yl)methylamino]carbonyl]amino]sulfonyl]benzoate} and chlorsulfuron {2-chloro-N-[[(4-methoxy-6-methyl-1,3,5triazin-2-yl)amino]carbonyl]benzenesulfonamide}, bis-carbamates such as Phenmedipham {3-[(methoxycarbonyl)amino]phenyl (3-methylphenyl)carbamate}; and

Fungicides: including thiocarbamates, particularly alkylenebis(dithiocarbamate)s, such as Maneb {[1,2ethanediylbis-[carbamodithiato](2-)]manganese} and Mancozeb {[[1,2-ethanediyl-bis[carbamodithiato]](2-)]manganese mixture with [[1,2-ethanediylbis[carbamodithiato]](2-)]zinc}, strobilurins such as azoxystrobin {methyl (E)-2-[[6-(2-cyanophenoxy)-4pyrimidinyl]oxy]-a-(methoxymethylene)benzeneacetate} 60 and kresoxim-methyl {(E)-a-(methoxyimino)-2-[(2methylphenoxy)methyl]benzeneacetic acid methyl ester}, dicarboximides such as iprodione {3-(3,5dichlorophenyl)Nisopropyl-2,4dioxo imidazolidine-1-carboxamide}; azoles such as propiconazole {1-[2-(2,4-dichloro-phenyl)-4-65 propyl-1,3-dioxolan-2-yl-methyl-1H-1,2,4-triazole}, and tebuconazole {(RS)-I-p-chlorophenyl-4,4-dimethyl-3-(IH1,2,4-triazole-1-ylmethyl)pentan-3-ol}; halophthalonitriles such as chlorothalonil {2,4,5,6-tetrachloro-1,3dicyanobenzene}; and inorganic fungicides such as Copper hydroxide {Cu(OH)2};

Insecticides: including benzoyl ureas such as Difiubenzuron {N-[[(4-chlorophenyl)amino]carbonyl]-2,6-5difiuorobenzamide)}; and carbamates such as carbaryl {I-naphthyl methylcarbamate}; Acaricides including: tetrazines such as Clofentezine {3,6-bis(2-chlorophenyl)-1,2,4,5-tetrazine}.

The agrochemical active may be water-soluble. Among water soluble active materials, non-selective herbicides, particularly N-(phosphono-methyl)glycine type herbicides such as glyphosate and sulphosate {respectively the iso-propyl-amino and trimethylsulphonium salts of N-phosphonomethyl glycine} and phosphinyl amino acids such as glufosinate {2-amino-4-(hydroxymethylphosphinyl) butanoic acid}, particularly as the ammonium salt. Such water soluble actives can be used as the sole active material in water dispersible granules, but more usually, they will be used in combination with water insoluble or immiscible active materials in multi-active formulations.

As used herein, fertilizer means any organic or inorganic material of natural or synthetic origin (other than liming materials) that is added to a soil to supply one or more plant nutrients essential to the growth of plants. Fertilizers typically provide, in varying proportions:
six macronutrients: nitrogen (N), phosphorus (P), potassium (K), calcium (Ca), magnesium (Mg), and sulfur (S);
seven micronutrients: boron (B), chlorine (Cl), copper (Cu), iron (Fe), manganese (Mn), molybdenum (Mo), and zinc (Zn).

The agrochemical active is generally supplied as a solution (SL) and the formulations can contain adjuvants, an antifreeze, a defoamer, dyes or other water soluble additives that are necessary to maximize efficacy or for an aesthetic effect. When the SL of an active is diluted into water and used alone there is typically no problems experienced during application. When applied together with a fertilizer, a water insoluble precipitant is formed, leading to problems during application and/or a reduction in efficacy. In order to prevent the precipitant and/or crystal formation, it is necessary to include an additive into either the formulation or directly into the spray medium.

Water soluble salts of aryloxyalkanoic acids as described herein include, for example, 2,4-D ((2,4-dichlorophenoxy)acetic acid), 2,4-DB, dichloroprop, mecoprop, MCPA, and MCPB. Pyridyloxyalkanoic acids as described herein include, for example, triclopyr and fluroxypyr. The water soluble salts of the aryloxyalkanoic acids and the pyridyloxyalkanoic acids include those containing an organo ammonium cation such as, but not limited to, monomethyl ammonium, isopropyl ammonium, butyl ammonium, dimethyl ammonium, diethyl ammonium, triethyl ammonium, monoethanol ammonium, diethanol ammonium, dimethylethyl ammonium, diethylethanol ammonium, triethanol ammonium, triisopropanol ammonium, tetramethyl ammonium, tetraethyl ammonium and N,N,N-trimethylethanol ammonium (choline), and cations made from dimethylaminopropylamine (DMAPA; N,N-dimethylpropane-1,3-diamine) and diethylenetriamine (DETA; bis(2-aminoethyl)amine), or mixtures thereof. Aqueous solutions containing the water soluble salts of an aryloxyalkanoic acids and pyridyloxyalkanoic acids may include herbicidal spray solutions or herbicide concentrates.

The methods and compositions described herein for improving the compatibility of aqueous herbicide solutions may also be used with aqueous solutions containing water soluble salts of aryl- and/or heteroarylcarboxylic acid herbicides such as aminopyralid, clopyralid, dicamba, picloram, and the like.

Water soluble salts of glyphosate as described herein include those salts where the cation is selected from potassium, sodium and ammonium, also organo ammonium such as, for example, isopropyl ammonium, dimethyl ammonium, triethyl ammonium, monoethanol ammonium, diethanol ammonium, triethanol ammonium, choline and the like, and trimethylsulfonium cation and mixtures thereof.

The inorganic cations as described herein are those that when present in appreciable amounts or concentrations may cause aqueous solutions of the water soluble salts of an aryloxyalkanoic acid or a pyridyloxyalkanoic acid, optionally containing glyphosate, to become incompatible and form solids. These inorganic cations include, for example, alkali metal cations, such as sodium and potassium; alkaline earth metal cations, such as calcium and magnesium; transition metal cations, such as manganese, copper, zinc and iron; and ammonium. Aqueous solutions containing water soluble salts of 2,4-D and glyphosate at pH levels below about pH 6.5 tend to be more incompatible in the presence of appreciable concentrations of inorganic cations than are such solutions at higher pH levels.

The term appreciable concentration of inorganic cations as used herein refers to the concentration of inorganic cations present in an aqueous solution containing at least one of a water soluble salt of herbicide, pesticide, plant growth regulator, mixtures thereof and the like, in the presence of at least one fertilizer in high concentrations, i.e., in concentrations of >16 wt %, that will lead to the precipitation of solids from that solution if all of the other conditions necessary for incompatibility of the solution exist, e.g., the composition and concentration of water soluble salts of an aryloxyalkanoic acid, water soluble salts of a pyridyloxyalkanoic acid, and/or water soluble salts of glyphosate, and the temperature, hardness and pH of the water. For example, a concentration of glyphosate potassium of about 0.8 weight percent (wt %) on an acid equivalent (ae) basis or higher in an aqueous solution at room temperature containing greater than about 0.8 wt % of 2,4-D DMA on an ae basis and made with water with a hardness of 342 parts per million (ppm) and a pH of about 5 will be incompatible. The compatibility of such a herbicide solution will depend, in addition to the other factors discussed herein, on the total concentration and actual composition of the inorganic cations present in the solution.

Ingredients that may contribute inorganic cations to the aqueous herbicide solutions described herein may include, but are not limited to, products or aqueous solutions containing fertilizers, micronutrients, hard water, co-formulation ingredients and the like, as well as, water soluble salts of glyphosate containing inorganic cations such as, for example, potassium, sodium, and ammonium.

Fertilizers are included in the methods and compositions described herein and may be dispersed or dissolved in water and may contain inorganic cations such as, for example, ammonium and potassium, in sufficient amounts so as to cause incompatibility problems when mixed with an aqueous solution containing the water soluble salt of at least one of an aryloxyalkanoic acid, a pyridyloxyalkanoic acid, and glyphosate. The amount of fertilizer that may be optionally included in the methods and compositions described herein is greater than or equal to 16 weight percent. Further examples of amounts of fertilizer that may be optionally included in the methods and compositions described herein include greater than or equal to 17 wt. percent, greater than or equal to 18 wt. percent, greater than or equal to 19 wt. percent, greater than or equal to 20 wt. percent, greater than or equal to 21 wt. percent, greater than or equal to 22 wt. percent, greater than or equal to 23 wt. percent, greater than or equal to 24 wt. percent, greater than or equal to 25 wt. percent, greater than or equal to 26 wt. percent, greater than or equal to 27 wt. percent, greater than or equal to 28 wt. percent, greater than or equal to 29 wt. percent, greater than or equal to 30 wt. percent, greater than or equal to 31 wt. percent, greater than or equal to 32 wt. percent, greater than or equal to 33 wt. percent, greater than or equal to 34 wt. percent, or greater than or equal to 35 wt. percent or greater than or equal to 38 wt. percent or greater than or equal to 40 wt. percent or greater than or equal to 45 wt. percent, or higher. Fertilizers may include, but are not limited to, ammonium sulfate (AMS), ammonium phosphate, ammonium nitrate, solutions of ammonium nitrate and urea which are commonly referred to in the art as 28% N or UAN, ammonium thiosulfate, potassium nitrate, potassium phosphate, potassium chloride, potassium carbonate and the like, and mixtures thereof. In addition to their fertilizer properties, AMS and UAN are commonly used as spray adjuvants or water conditioning agents with glyphosate herbicide treatments in order to improve biological efficacy. Thus, AMS is often mixed with glyphosate and the methods and compositions described herein can be used to improve compatibility when these solutions are combined with aqueous herbicide solutions containing a water soluble salt of an aryloxyalkanoic acid and/or a water soluble salt of a pyridyloxyalkanoic acid.

Micronutrients useful with the methods and compositions described herein may include one or more nutrients essential to plant growth and health that are only needed in very small quantities and may contain, among other things, one or more inorganic cations such as, for example, the cations of manganese, copper, iron, molybdenum and zinc. The micronutrients may be added to aqueous herbicide spray solutions containing water soluble salts of an aryloxyalkanoic acid, pyridyloxyalkanoic acid, and/or glyphosate for economical delivery to crop plants. Compatibility problems of these aqueous herbicide spray solutions may occur if the conditions for incompatibility of these solutions exist as described herein.

Organo ammonium cations that may cause incompatibility in the aqueous herbicide solutions described herein, particularly in concentrates and pre-mix concentrates, include monomethyl ammonium, isopropyl ammonium, butyl ammonium, dimethyl ammonium, diethyl ammonium, triethyl ammonium, monoethanol ammonium, diethanol ammonium, dimethylethyl ammonium, diethylethanol ammonium, triethanol ammonium, triisopropanol ammonium, tetramethyl ammonium, tetraethyl ammonium and N,N,N-trimethylethanol ammonium (choline), or mixtures thereof.

Co-formulation ingredients useful with the methods and compositions described herein include those products or ingredients that contain inorganic cations and may be selected from one or more of adjuvants, antifoam agents, antimicrobial agents, buffering agents, corrosion inhibitors, defoaming agents, deposition agents, dispersants, dyes, freezing point depressants, neutralizing agents, penetration aids, sequestering agents, spray drift control agents, spreading agents, stabilizers, sticking agents, suspension aids, viscosity-modifying additives, wetting agents and the like.

The polymeric crystallization inhibitors described herein may be used to improve the compatibility of aqueous herbicide solutions containing a water soluble salt of at least one herbicide including but not limited to a water soluble salt of an aryloxyalkanoic acid, a water soluble salt of a pyridyloxyalkanoic acid, and/or a water soluble salt of glyphosate in the presence of a high concentration of fertilizer, i.e., >16% of one or more fertilizers, in spray tank mixtures, concentrates, or pre-mix concentrates. In aqueous spray tank mixtures, the polymeric crystallization inhibitor of Formula I may comprise, with respect to the aqueous herbicide spray solution of improved compatibility, from 0.01 to 5 weight percent, from 0.01 to 4 weight percent, from 0.01 to 3 weight percent, from 0.01 to 2 weight percent, from 0.01 to 1 weight percent, from 0.05 to 2 weight percent, from 0.05 to 1 weight percent, from 0.05 to 0.5 weight percent, from 0.1 to 0.4 weight percent, from 0.15 to 0.3 weight percent, or from 0.15 to 0.25 weight percent. In aqueous concentrates and aqueous pre-mix concentrates, the polymeric crystallization inhibitor of Formula I may comprise, with respect to the aqueous herbicide solution of improved compatibility, from 0.05 to 10 weight percent, from 0.05 to 8 weight percent, from 0.05 to 6 weight percent, from 0.1 to 5 weight percent, from 0.2 to 5 weight percent, from 0.3 to 5 weight percent, from 0.4 to 5 weight percent, from 0.5 to 5 weight percent, from 0.5 to 4 weight percent, from 0.5 to 3 weight percent, from 1 to 3 weight percent, or from 1.5 to 2.5 weight percent.

In some instances, the polymeric crystallization inhibitors described herein can contain inorganic ions that could cause or add to the concentration of inorganic ions in a solution that cause incompatibility. In such cases, the polymeric crystallization inhibitor chosen should be be able to compatibilize the overall inorganic ion concentration after addition of the polymeric crystallization inhibitor. Alternatively, a polymeric crystallization inhibitor of Formula I that does not contain inorganic cations such as, for example, a polyacrylate co-polymer of Formula I where the carboxyl groups are in the acid or organo ammonium salt form can be used. Such polymeric crystallization inhibitors of Formula I that do not contain inorganic cations may be particularly useful for improving the storage stability of aqueous herbicide concentrates and pre-mix concentrates in ambient and sub-ambient temperature conditions.

Without intending to be bound by theory, the polymeric crystallization inhibitors described herein are believed to improve the compatibility of aqueous herbicide solutions with fertilizer by preventing or inhibiting the crystallization or precipitation of solids. The relative effectiveness of the polymeric crystallization inhibitors in preventing the formation of these solids can be estimated by measuring the on-set pH of crystallization (OSPOC) of the solids in a titration analysis procedure. The OSPOC of a particular composition can be measured by titrating a solution of an aryloxyalkanoic or pyridyloxyalkanoic acid salt of an inorganic cation such as, for example, the potassium salt of 2,4-D with a strong acid such as, for example, sulphuric acid until solids or crystals begin forming at a particular pH value (the OSPOC). The lower the OSPOC observed with the use of any particular polymeric crystallization inhibitor described herein, the better it may perform at preventing crystallization in, and therefore improving the compatibility of, an aqueous herbicide solution as described herein.

Alternatively, the relative effectiveness of the polymeric crystallization inhibitors described herein at improving the compatibility of the aqueous herbicide solutions described herein can be determined by measuring the Critical Crystallization Concentration (CCC) of the aryloxyalkanoic or pyridyloxyalkanoic acid salt of an inorganic cation such as, for example, the potassium salt of 2,4-D in a tank mix solution. The CCC of a particular composition can be measured by preparing saturated and over saturated solutions or mixtures of the composition and then measuring the concentration of the aryloxyalkanoic acid remaining in solution. The higher the CCC observed with the use of a particular polymeric crystallization inhibitor, the better it may perform at preventing crystallization in, and therefore improving the compatibility of the aqueous herbicide solutions described herein.

The aqueous herbicide solutions described herein that may be compatibilized using the polymeric crystallization inhibitors described herein include concentrates, pre-mix concentrates, and spray solutions prepared by diluting such a concentrate or pre-mix concentrate, or by tank mixing multiple components of a spray solution. The aqueous herbicide concentrate or pre-mix concentrate may comprise the use of, with respect to the total composition, from 0.05 weight percent to 10 weight percent, from 0.05 to 8 weight percent, from 0.05 to 6 weight percent, from 0.1 to 5 weight percent, from 0.2 to 5 weight percent, from 0.3 to 5 weight percent, from 0.4 to 5 weight percent, from 0.5 to 3 weight percent, from 1 to 3 weight percent, or from 1.5 to 2.5 weight percent of one or more of the polymeric crystallization inhibitors described herein and from about 20 to about 60 weight percent on an acid equivalent basis of at least one of a water soluble salt of an aryloxyalkanoic acid (such as 2,4-D), a water soluble salt of a pyridyloxyalkanoic acid (such as triclopyr), and a water soluble salt of glyphosate, or a pre-mix containing one or more of these salts. The aqueous herbicide concentrate or pre-mix concentrate of improved compatibility is preferably a solution containing the polymeric crystallization inhibitor dissolved or dispersed in the concentrate which, upon dilution in water with products or solutions and at conditions that are normally prone to cause incompatibility as described herein, forms an herbicide spray solution of improved compatibility. The herbicide spray solution of improved compatibility may also be prepared by tank mixing the individual components of the spray solution at the point of use. Such a spray solution may also be combined with or diluted with products or solutions and at conditions that are normally prone to cause incompatibility, as described herein, to form an herbicide spray solution of improved compatibility.

Use of the polymeric crystallization inhibitors as described herein in aqueous spray solutions containing soluble salts of 2,4-D, soluble salts of glyphosate, and inorganic cations provides solutions of improved compatibility at pH levels below about 6.5. Additionally, improved compatibility can be provided below about pH 5.5. Further, improved compatibility can be provided below about pH 5.

A compatible aqueous spray solution containing the water soluble salts of glyphosate and 2,4-D can be prepared by adding the aqueous soluble concentrates of the salts of glyphosate and 2,4-D to an aqueous solution containing the polymeric crystallization inhibitor of Formula I. Other co-formulation ingredients such as water soluble or water dispersible ingredients including, but not limited to, dispersing agents, wetting agents, spray drift reduction agents, fertilizers, and antifoam agents, may optionally be added to the spray solution.

As described herein, a compatibilized aqueous herbicide concentrate is a solution containing the polymeric crystallization inhibitor dissolved or dispersed in the concentrate which upon dilution in water with products or solutions and at conditions that are normally prone to cause incompatibility, also as described herein, forms a herbicide spray solution of improved compatibility.

In a typical method for preparing the compatible aqueous herbicide concentrate using the methods and compositions described herein, one or more polymeric crystallization inhibitor of Formula I, a water soluble salt of at least one herbicidal active ingredient, for example one of 2,4-D and/or glyphosate, fertilizer, and any additional ingredients, are mixed together in water to provide the aqueous concentrate. The order of addition of ingredients and the mixing conditions can be determined by one of ordinary skill in the art.

The methods and compositions described herein also include a dry herbicide composition including a water soluble salt of 2,4-D and/or a water soluble salt of glyphosate, at least one fertilizer in an amount of 16% or higher, and one or more polymeric crystallization inhibitors of structure I as described above. A dry herbicide composition can include from 0.05 to 10 weight percent, from 0.05 to 8 weight percent, from 0.05 to 6 weight percent, from 0.1 to 5 weight percent, from 0.2 to 5 weight percent, from 0.3 to 5 weight percent, from 0.4 to 5 weight percent, from 0.5 to 10 weight percent, from 0.5 to 5 weight percent, from 0.5 to 4 weight percent, from 0.5 to 3 weight percent, from 1 to 3 weight percent, or from 1.5 to 2.5 weight percent of one or more polymeric crystallization inhibitors of Formula I and from about 20 to about 80 weight percent on an acid equivalent basis of a water soluble salt of 2,4-D or a water soluble salt of glyphosate, or a mixture of water soluble salts of 2,4-D and glyphosate. Dry herbicide compositions as described herein form a herbicide spray solution of improved compatibility upon dissolution in water with products or solutions and at conditions that are normally prone to cause incompatibility as described herein.

In a typical method for preparing the dry herbicide composition, the one or more polymeric crystallization inhibitors, the water soluble salt of at least one of 2,4-D and glyphosate, and optionally, any additional ingredients, are mixed together in water to provide an aqueous concentrate. The order of addition of ingredients and the mixing conditions used can easily be determined by one of ordinary skill in the art. The aqueous concentrate may then be concentrated by removal of water and then dried to provide the dry herbicide composition which may also be prepared by dry blending the ingredients described herein. The dry composition can be added to an aqueous spray solution containing products or solutions and at conditions that are normally prone to cause incompatibility, as described herein, to form a herbicide spray solution of improved compatibility. It is commonly known that concentrated or dry formulations may be diluted or dissolved in water at from about 10 to about 500 fold dilution at the point of use depending on the agricultural practices.

The methods and compositions described herein can be used for the control of undesired plant growth. In such a use, a herbicidally effective amount of the aqueous spray solution of improved compatibility is applied to an area of soil or targeted plant foliage to kill or provide suitable control of undesirable weed plants.

The effective amount of the active ingredients used in the methods and compositions described herein to be employed in a typical agricultural application often depends upon, for example, the type of plants, the stage of growth of the plants, severity of environmental conditions, the weeds to be controlled and application conditions. Typically, a weed plant in need of control is contacted with an aqueous herbicidal spray solution that contains from about 0.01 to about 10 weight percent, preferably from about 0.1 to about 5 weight percent of a herbicide active ingredient on an acid equivalent basis with respect to the total aqueous spray solution. The contacting may be in any effective manner. For example, any exposed part of the plant, e.g., leaves or stems may be sprayed with the active ingredient as a solution in a carrier such as water.

The methods and compositions described herein are especially useful for the control of weeds in crops that are naturally tolerant to or have been made tolerant to or resistant to the herbicides contained in the spray solution by genetic manipulation or by mutation and selection. For example, corn, wheat, rice, soybean, sugar beet, cotton, canola, and other crops that have been made tolerant to or resistant to glyphosate and are naturally tolerant or resistant to or have been made genetically tolerant or resistant to 2,4-D can be treated. The aqueous herbicidal spray solutions of the present invention are also effective in controlling many weeds that have become resistant to glyphosate, for example, horseweed (Conyza canadensis, ERICA).

Optionally, the methods and compositions described herein may additionally contain one or more surfactants. The surfactants can be anionic, cationic, or nonionic in character. Typical surfactants include salts of alkyl sulfates, such as diethanol-ammonium lauryl sulfate; alkylarylsulfonate salts, such as calcium dodecylbenzene-sulfonate; alkyl and/or arylalkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalenesulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; ethoxylated amines, such as tallowamine ethoxylated; betaine surfactants, such as cocoamidopropyl betaine; polyethylene glycol esters of fatty acids, such as polyethylene glycol stearate; block copolymers of ethylene oxide and propylene oxide; salts of mono and dialkyl phosphate esters; and mixtures thereof. The amounts and combinations of these surfactants to be used can easily be determined by one of ordinary skill in the art. As discussed above for polymeric crystallization inhibitors, it may be advantageous to avoid the use of surfactants that contain inorganic ions such as, for example, Na⁺, K⁺, or NH₄⁺ at a level that will impact crystallization in order to maintain the intended physical stability of the compositions.

In addition to the specific methods and compositions set forth above, the methods and compositions described herein also may include compositions containing one or more additional compatible ingredients. These additional ingredients may include, for example, one or more pesticides or other ingredients, which may be dissolved or dispersed in the composition and may be selected from acaricides, algicides, antifeedants, avicides, bactericides, bird repellents, chemosterilants, defoliants, desiccants, disinfectants, fungicides, herbicide safeners, herbicides, insect attractants, insecticides, insect repellents, mammal repellents, mating disrupters, molluscicides, plant activators, modifiers of plant size and structure, rodenticides, semiochemicals, synergists and virucides. Also, any other additional ingredients providing functional utility such as, for example, antifoam agents, antimicrobial agents, buffers, corrosion inhibitors, dispersing agents, dyes, fragrants, freezing point depressants, neutralizing agents, odorants, penetration aids, sequestering agents, spray drift control agents, spreading agents, stabilizers, sticking agents, viscosity-modifying additives, and the like, may be included in these compositions.

The invention will now be illustrated by the following non-limiting examples.

### Example 1

An initial charge of 100 g of water, 0.0172 grams of ferrous ammonium sulfate hexahydrate and 107 g of isopropyl alcohol were added to a glass reactor. The reactor contents were heated to reflux (approximately 84° C.). At reflux, continuous additions of a mixture of 75.6 g of acrylic acid and 46.8 of styrene (30 mole %), were added over a period of 3.5 hours. A solution of 4.9 g of sodium persulfate and 17.5 grams of 35% hydrogen peroxide dissolved in 25 g of water was simultaneously added but over a period of 4 hours. A solution of 3.1 grams of 3-mercaptopropionic acid dissolved in 60 grams of water was simultaneously added over 3 hours and 15 minutes. The reaction temperature was maintained at about 85-88° C. for one hour. A small amount of ANTIFOAM 1400 (0.12 g) (from Dow Chemical) was added to suppress any foam generated during distillation. The alcohol co-solvent was removed from the polymer solution by azeotropic distillation. During the distillation, a mixture of 70 grams of diethanolamine dissolved in 50 grams of water was slowly dripped into the reactor. Approximately 160 g of a mixture of water and isopropyl alcohol were distilled off. The final solids of the polymer solution was approximately 40%.

### Example 2

An initial charge of 125 g of water, 0.02 grams of ferrous ammonium sulfate hexahydrate and 325 g of isopropyl alcohol were added to a glass reactor. The reactor contents were heated to reflux (approximately 84° C.). At reflux, continuous additions of a mixture of 151.2 g of acrylic acid and 158.6 of benzylmethacrylate (30 mole %) and 30 grams of isopropanol were added over a period of 3 hours. A solution of 9.3 g of sodium persulfate and 27.5 grams of 35% hydrogen peroxide dissolved in 80 g of water was simultaneously added but over a period of 3.5 hours. A solution of 3.5 grams of 3-mercaptopropionic acid dissolved in 50 grams of water was simultaneously added over 2 hours and 45 minutes. The reaction temperature was maintained at about 85-88° C. for one hour. A small amount of ANTIFOAM 1400 (0.1 g) (from Dow Chemical) was added to suppress any foam generated during distillation. The alcohol co-solvent was removed from the polymer solution by azeotropic distillation. During the distillation, a mixture of 100 grams of diethanolamine dissolved in 200 grams of water was slowly dripped into the reactor. Approximately 460 g of a mixture of water and isopropyl alcohol were distilled off. The resulting product was diluted with 400 grams of water and the final solids of the polymer solution was approximately 35%.

### Example 3

An initial charge of 100 g of water, 0.0199 grams of ferrous ammonium sulfate hexahydrate and 175 g of isopropyl alcohol were added to a glass reactor. The reactor contents were heated to reflux (approximately 84° C.). At reflux, continuous additions of a mixture of 32.4 g of acrylic acid and 109.2 of styrene (70 mole %) were added over a period of 3.5 hours. A solution of 5.7 g of sodium persulfate and 20.2 grams of 35% hydrogen peroxide dissolved in 25 g of water was simultaneously added but over a period of 4 hours. A solution of 5.7 grams of 3-mercaptopropionic acid dissolved in 60 grams of water was simultaneously added over 3 hours and 15 minutes. The reaction temperature was maintained at about 85-88° C. for one hour. A small amount of ANTIFOAM 1400 (0.1 g) (from Dow Chemical) was added to suppress any foam generated during distillation. The alcohol co-solvent was removed from the polymer solution by azeotropic distillation. During the distillation, a mixture of 32.4 grams of 50% NaOH dissolved in 200 grams of water was slowly dripped into the reactor. Approximately 260 g of a mixture of water and isopropyl alcohol were distilled off. The final solids of the polymer solution was approximately 35%.
Other polymers useful in this invention can be synthesized by the processes described in U.S. Pat. No. 5,650,473 and the procedures detailed in Example 1-3. These polymers are detailed in the table below:

| | |
|---|---|
| Example 4 | 20% styrene + 40% itaconic acid + 40% sodium |
| | styrene sulfonate |
| Example 5 | 34% styrene + 6% AMPS + 60% AA, Na salt |
| Example 6 | 68% AA + 13% sodium methallyl sulfonate + |
| | 15.4% methylmethacrylate + 2.4% AMPS + |
| | 1.4% sulfophenyl methallyl ether |
| Example 7 | 3.9% laurylmethacrylate + 96.1% AA |
| Example 8 | 25% BzMA + 10% AMPS + 65% AA, Na salt |
| Example 9 | 60% AA + 40% styrene, Na salt |
| Example 10 | 70% AA + 30% styrene, Na salt |
| Example 11 | 37.5% BzMA + 10% AMPS + 52.5% AA, Na salt |
| Example 12 | 29% BzMA + 10% AMPS + 61% AA, Na salt |
| Example 13 | 25% BzMA + 10% AMPS + 65% AA, Na salt |
| Example 14 | 25% BzMA + 10% AMPS + 65% AA, Na salt |
| Example 15 | 20% BzMA + 80% AA, DEA salt |
| Example 16 | 10% 2-EHA + 10% AMPS + 80% AA, Na salt |
| Example 17 | 15% 2-EHA + 10% AMPS + 75% AA, Na salt |
| Example 18 | 20% 2-EHA + 10% AMPS + 70% AA, Na salt |

¹ AA = acrylic acid; AMPS = 2-acrylamido-2-methylpropane sulfonic acid; BzMA = benzyl methacrylate; DEA = diethanolamine; Na = sodium; 2-EHA = 2-ethylhexyl acrylate.

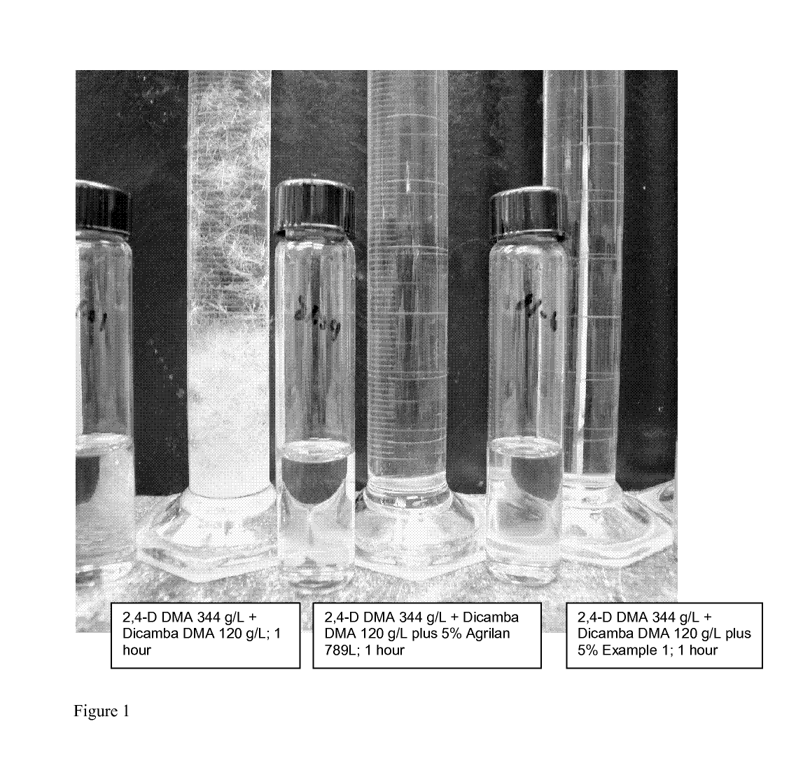

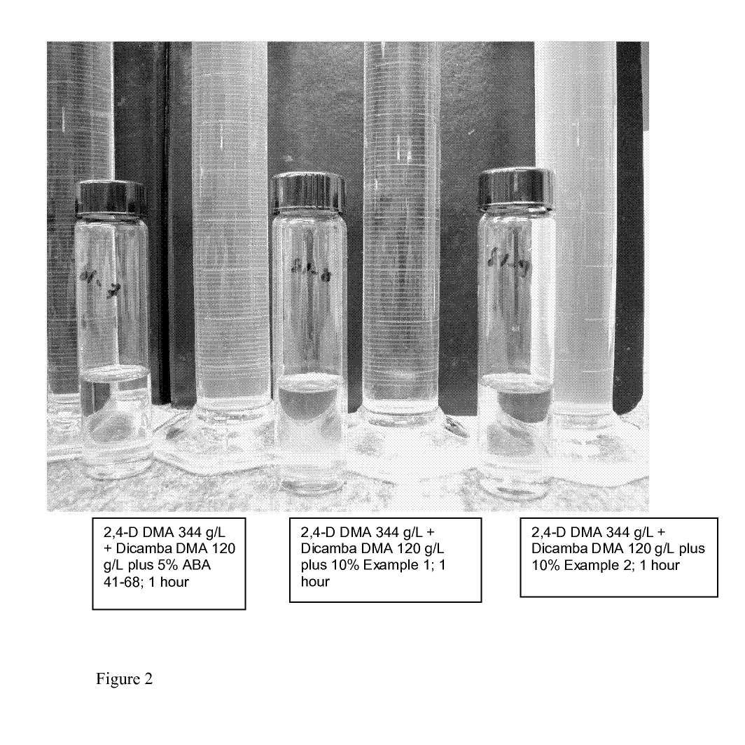

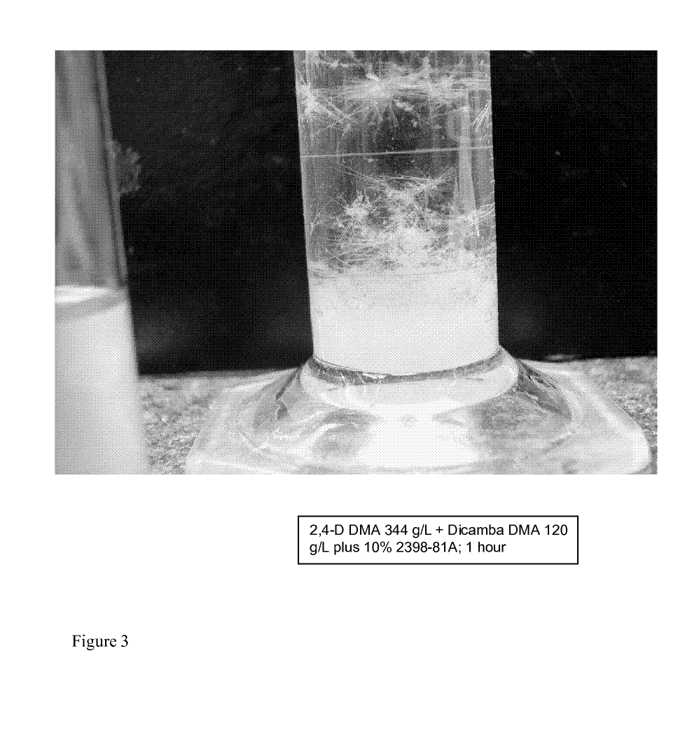

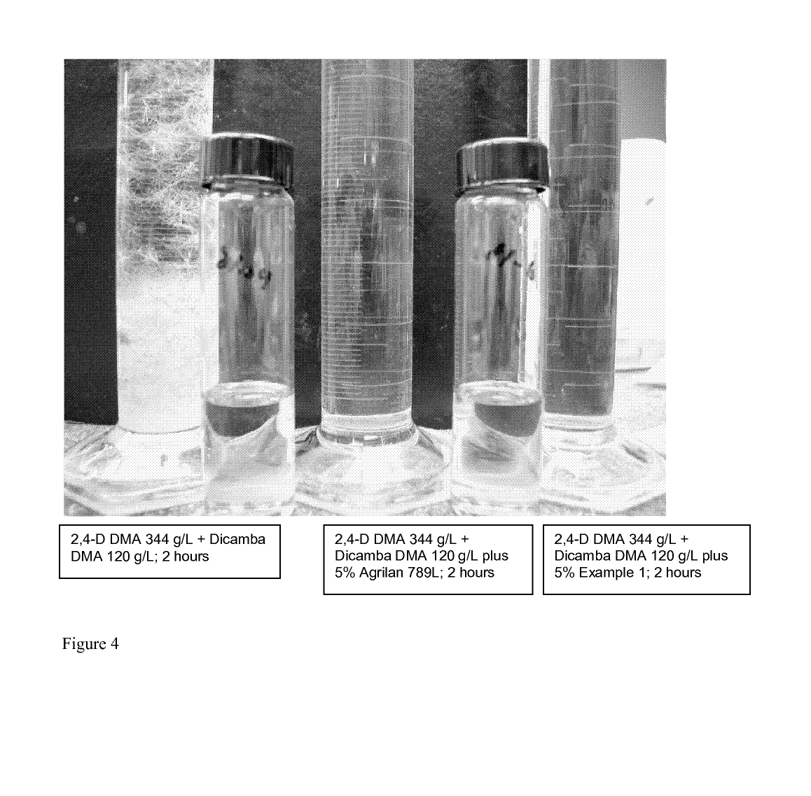

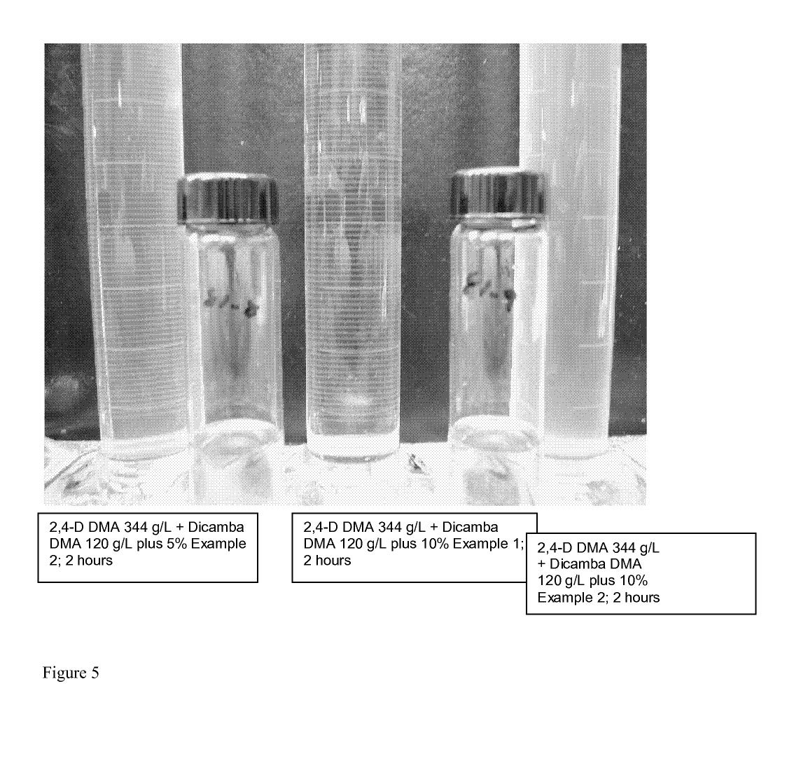

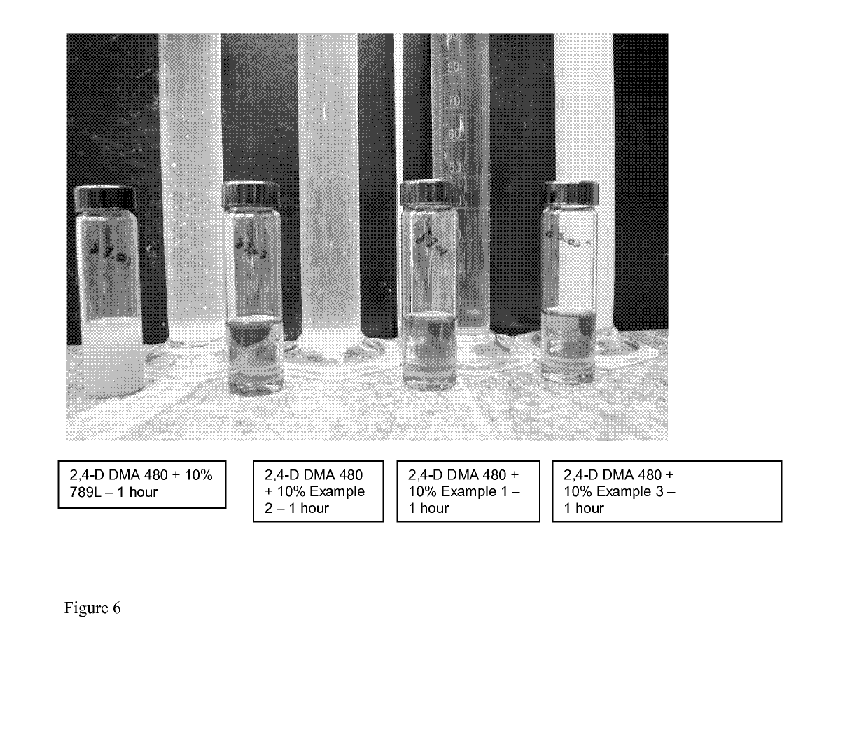

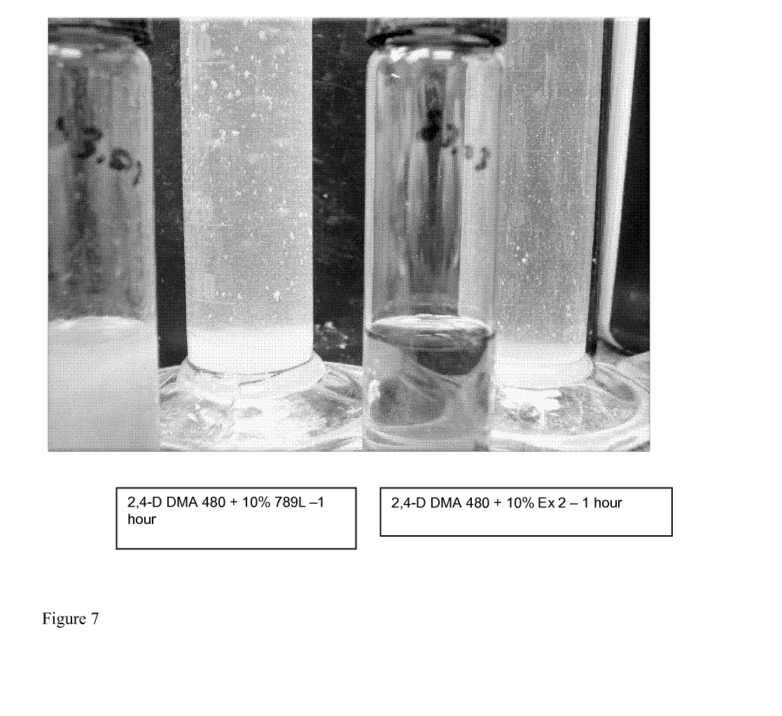

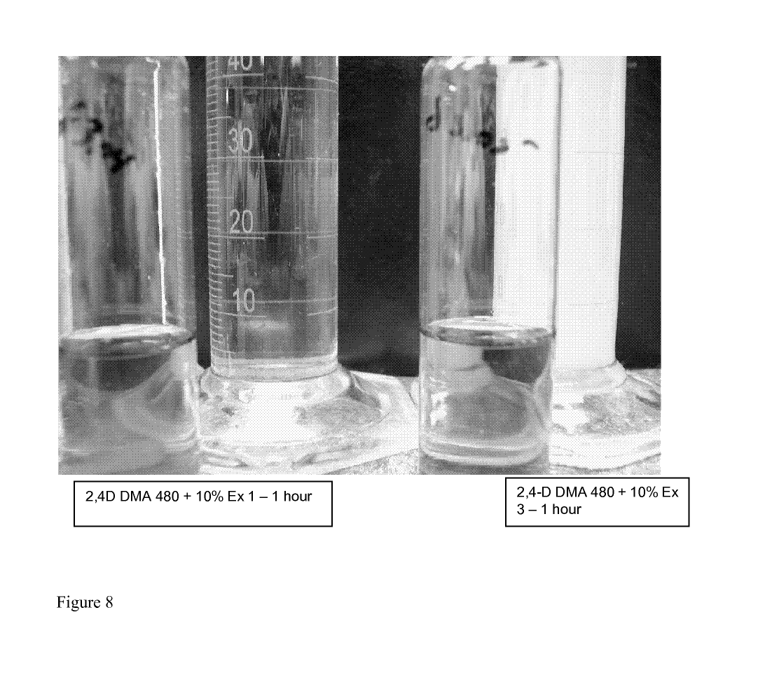

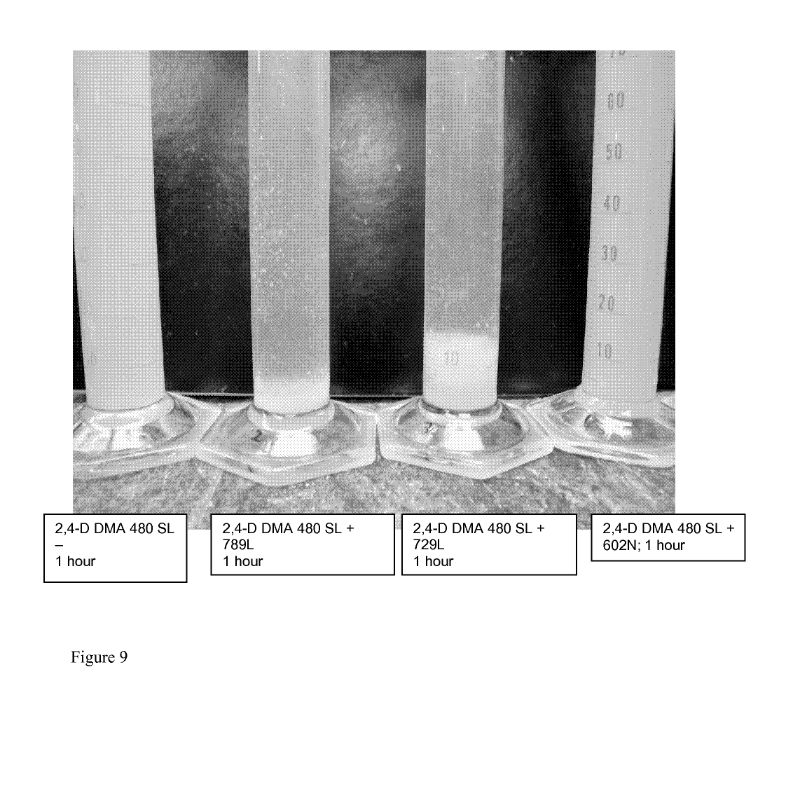

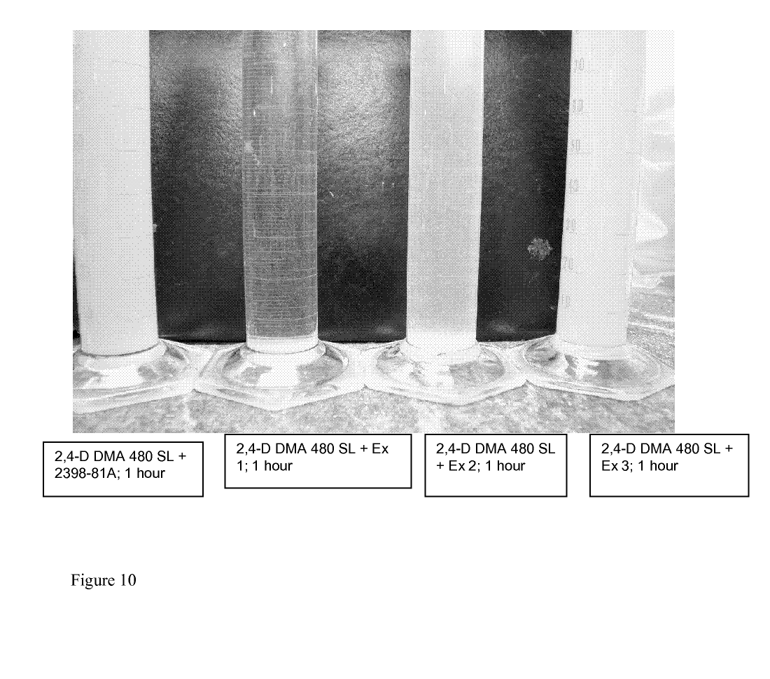

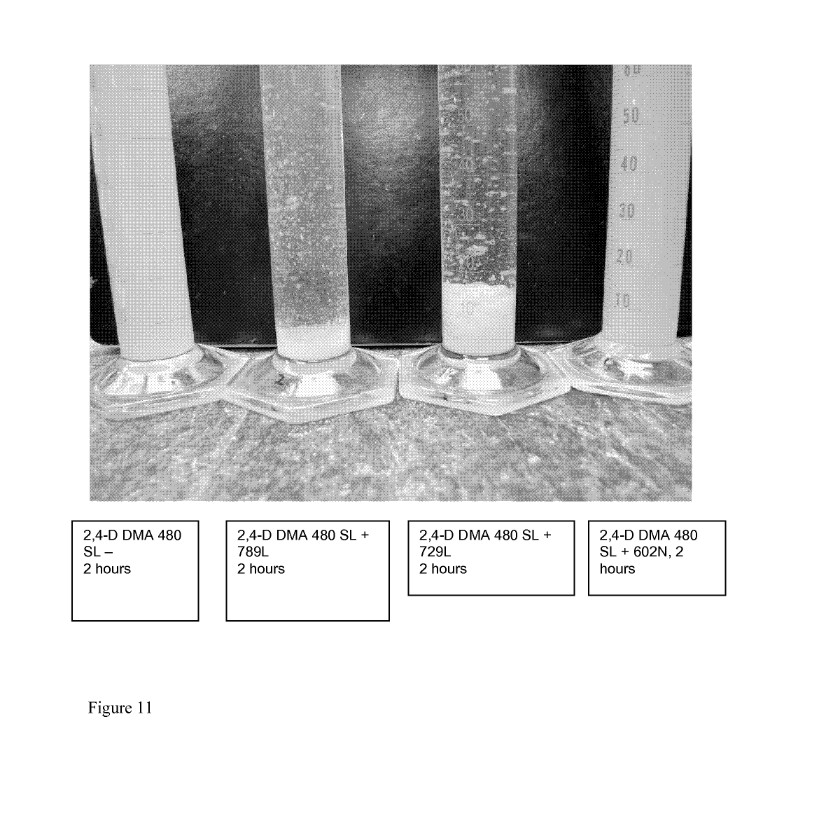

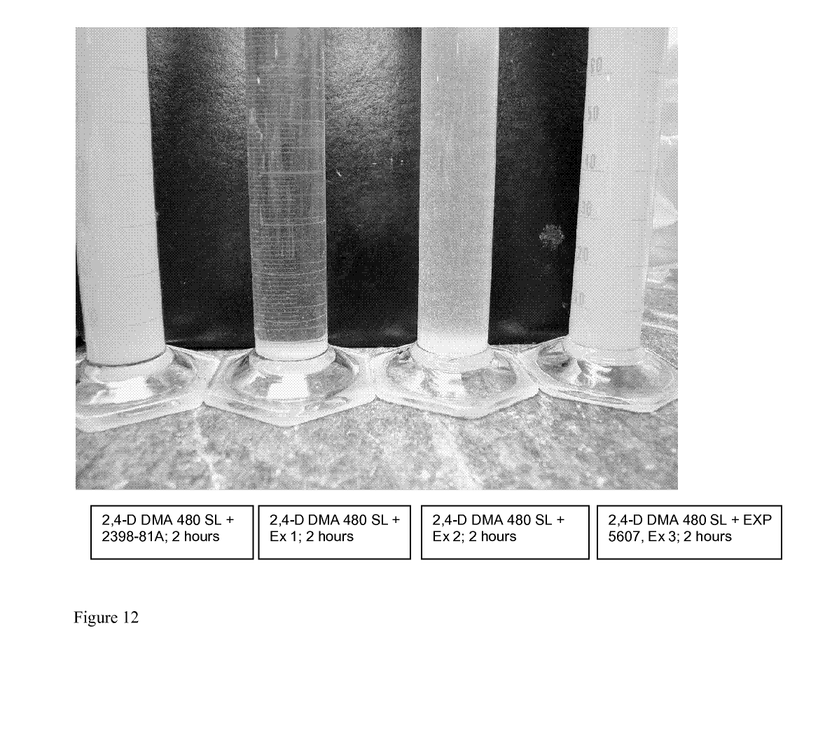

The use of these polymers are detailed in the examples below:
A mixture of 2,4D DMA (344 g/L) plus Dicamba DMA (120 g/L) was evaluated for compatibility with 30-0-0 (urea-ammonium nitrate) fertilizer. The dilution rates tested were 5 mls of herbicidal mixture diluted into 95 mls of 30-0-0. All tests were conducted at room temperature. A series of polymers were tested in the herbicide solution, and they were:
Agrilan 789L pH adjusted to 6.5 with NaOH. The Agrilan 789L is a copolymer of acrylic acid, benzylmethacrylate (BzMA) and AMPS available from AkzoNobel Surface Chemistry.
Alcosperse 602N—polyacrylic acid, sodium salt
Example 1—30 mole % styrene+70 mole % AA, diethanolamine salt
Example 2—30 mole % benzylmethacrylate+70 mole % AA, diethanolamine salt
2398-81A—Alcosperse 602 acid pH adjusted to 5.8 with diethanolamine
   When 10% w/w of Agrilan 789L and Alcosperse 602N was added to the herbicide solution, there was a rapid formation of a precipitant. That was most likely a sodium or partial sodium salt of 2,4-D. When the 789L was reduced to 5% w/w there was no precipitant formed. At 5% w/w of Alcosperse 602N the precipitant was still formed. That is due to the higher mole % of sodium present in the 602N compared to 789L. Since there was precipitant in the concentrate with 602N, the dilutions were not tested. The results after one hour standing are depicted in FIGS. 1 to 3.
   The results after two hours standing are depicted in FIGS. 4 and 5
   At the one hour interval there was a large concentration of crystals were present in the herbicide blend with no polymer added.
   The haze present in the dilutions containing the polymer of Example 2 is not due to the precipitation of a 2,4-D salt. It is due to the low solubility of the polymer. The diethanolamine salt of Alcosperse 602 did not perform well as a compatibility agent/crystal inhibitor. That was due to the lack of a hydrophobic monomer present in the polymer. To date, no non-hydrophobically modified polymers have been acceptable as crystal inhibitors/compatibility agents with the water soluble actives tested. After two hours, there was little to no change present in the fertilizer solutions.
   The same study was repeated with a 2,4-D DMA 480 g/L SL. The polymers tested were:
Agrilan 789L pH adjusted to 6.5 with NaOH. Alcosperse 729L—copolymer of acrylic acid, styrene and AMPS available from AkzoNobel Surface Chemistry.
Alcosperse 602N—polyacrylic acid, sodium salt
Example 1—30 mole % styrene+70 mole % AA, diethanolamine salt
Example 2—30 mole % benzylmethacrylate+70 mole % AA, diethanolamine salt
2398-81A—Alcosperse 602 acid pH adjusted to 5.8 with diethanolamine
Aquatreat AR 545—hydrophobically modified by using methacrylic acid in the polymer
Agrilan 700L—copolymer of methacrylic acid, AMPS and 2-ethylhexyl acrylate available from AkzoNobel Surface Chemistry.
Example 3—70 mole % styrene+30 mole % AA, sodium salt
   At 5% w/w of the polymer solution in the SL, none of the fertilizer dilutions performed well, as all had a large quantity of precipitant present. The polymer solution concentration was increased to 10% w/w. The results are depicted in FIGS. 6 to 8.
   The high concentration of polymer needed with the 480 g/1 SL leads to a precipitation with Agrilan 789L. The sodium counter ion concentration was high enough to form a 2,4-D sodium salt, or a partial sodium salt, that led to the precipitant formation. There is a trace amount of precipitant present with the polymer of Example 1, but that was by far and away the best performing polymer in the study. Interestingly, the polymer of Example 1 performed much better than the polymer of Example 2. That is due to the difference between styrene, present in Example 1, and benzylmethacrylate, present in Example 2. Another interesting occurrence was that the polymer of Example 3 did not perform well in the 480 g/L SL. That could be due to two factors —1) the styrene content is too high at 70 mole %, or 2) that the difference in counter ions had a pronounced effect.
   The samples that contained Agrilan 700L and Aquatreat AR 545 experience heavy precipitation immediately upon dilution.
   The concentration of the polymers in the 2,4-D DMA 480 SL when diluted into the fertilizers is approximately 0.175% v/v. The concentration was increased to 0.25% v/v and added directly to the fertilizers in order to test the potential for tank mix application. The results are depicted in FIGS. 9 to 12.
   The polymer of Example 1 performed well. There is a trace amount of precipitant in the Example 1 dilution but sunstantially less than the other polymers. There is the possibility that increasing the polymer concentration slightly would eliminate that precipitation. The only concern with the polymer of Example 1 is that the polymer had a longer dissolution time. In contrast, the polymer of Example 2 solubilized instantly. The dissolution time for the polymer of Example 1 could be reduced by the insertion of benzylmethacrylate into the polymer. Another contrast is between the polymer of Example 1 and 729L. The 729L solubilized instantly due to AMPS but performed poorly as a crystal inhibitor/compatibility agent. The increase in the solubility of the polymer due to AMPS inhibits absorption, therefore, reducing performance.

1. A method of improving the compatibility of an aqueous herbicide solution comprising at least one of a water soluble salt of a herbicidal active and concentrated fertilizer, wherein said concentrated fertilizer comprises >16 wt % of one or more fertilizers, said method comprising adding to the aqueous herbicide solution one or more polymeric crystallization inhibitors of structure I
AₓB_{y}C_{z} I
wherein A is 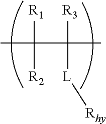
wherein R₁, R₂, and R₃ are independently H, CH₃, COOH, or CH₂COOH, L is a linking group comprising —C(══O)—O—, —C(══O)—N—, —CH₂—, —O—, —O—C(══O)—, urethane, urea or a direct bond, and R_{hy} is hydrophobic and comprises a linear or branched alkyl, cycloalkyl, aryl, alkaryl or alkoxylated derivative thereof;
B is derived from polymerizing an ethylenically unsaturated carboxylic acid monomer and/or its salts; and
C is optional and is derived from polymerizing an ethylenically unsaturated sulfonic acid monomer or phosphonic acid monomer and/or its salts, and x is the mole percent of A and is from about 5 to 80%, z is the mole % of C and is from about 0 to 25%, and y is the mole % of B, which is from about 1 to 95 mole %.

2. The method of claim 1, wherein the herbicidal active is a water soluble salt of aryloxyalkanoic acid, a water soluble salt of a pyridyloxyalkanoic acid, a water soluble salt of glyphosate, or combinations and/or mixtures thereof.

3. The method of claim 1, wherein the aryloxyalkanoic acid is 2,4-D, 2,4-DB, dichlorprop, mecoprop, MCPA, or MCPB, and the pyridyloxyalkanoic acid is triclopyr or fluroxypyr.

4. The method of claim 1, wherein R_{hy} is a linear aryl moiety.

5. The method of claim 1, wherein R_{hy} is naphthyl, ethoxylated naphthyl, phenyl, ethoxylated phenyl, benzyl, or ethoxylated benzyl.

6. The method of claim 1, wherein the one or more fertilizers is ammonium sulfate.

7. The method of claim 1, further comprising one or more inorganic cations selected from the group consisting of NH₄⁺, Na⁺, ca²⁺, Mg²⁺, Fe²⁺, Fe³⁺, Cu²⁺, Mn²⁺, and Zn²⁺, or one or more organo ammonium cations selected from the group consisting of monomethyl ammonium, isopropyl ammonium, butyl ammonium, dimethyl ammonium, diethyl ammonium, triethyl ammonium, monoethanol ammonium, diethanol ammonium, dimethylethyl ammonium, diethylethanol ammonium, triethanol ammonium, triisopropanol ammonium, tetramethyl ammonium, tetraethyl ammonium and N,N,N-trimethylethanol ammonium (choline), and cations made from dimethylaminopropylamine and diethylenetriamine, or mixtures thereof.

8. The method of claim 1, wherein the aqueous herbicide solution is a concentrate or a pre-mix concentrate.

9. The method of claim 8, wherein the aqueous herbicide solution is a concentrate containing water soluble salts of 2,4-D and/or glyphosate.

10. The method of claim 1, wherein the aqueous herbicide solution is a spray solution.

11. The method of claim 1, wherein the polymeric crystallization inhibitor is a co-polymer containing polyacrylate groups, polymethacrylate groups or polymaleate groups, or mixtures thereof.

12. The method of claim 11, wherein the co-polymer containing polyacrylate groups comprises hydrophobically modified groups derived from the polymerization of an acrylate monomer and a styrene or substituted styrene monomer.

13. The method of claim 1, wherein the polymeric crystallization inhibitor is in the form of a salt.

14. The method of claim 13, wherein the salt is an organic amine salt or an inorganic alkaline salt.

15. The method of claim 13, wherein the salt contains an organo ammonium cation selected from monomethyl ammonium, isopropyl ammonium, butyl ammonium, dimethyl ammonium, diethyl ammonium, triethyl ammonium, monoethanol ammonium, diethanol ammonium, dimethylethyl ammonium, diethylethanol ammonium, triethanol ammonium, triisopropanol ammonium, tetramethyl ammonium, tetraethyl ammonium and N,N,N-trimethylethanol ammonium (choline), and cations made from dimethylaminopropylamine and diethylenetriamine, or mixtures thereof.

16. The method of claim 1, wherein the polymeric crystallization inhibitor of structure I is comprised of, with respect to the total weight of the polymeric crystallization inhibitor of structure I, 5 to 80 mole percent A, and 0 to 25 mole % C, with the rest being B.

17. An aqueous herbicide solution having improved compatibility, wherein said solution comprises a water soluble salt of one or more herbicidal actives and at concentrated fertilizer, wherein said concentrated fertilizer comprises >16 wt % of at least one fertilizer based on the total weight of the solution, and one or more polymeric crystallization inhibitors of structure I
AₓB_{y}C_{z} I
wherein A is 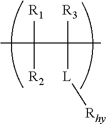
wherein R₁, R₂, and R₃ are independently H, CH₃, COOH, or CH₂COOH, L is a linking group comprising —C(══O)—O—, —C(══O)—N—, —CH₂—, —O—, —O—C(══O)—, or a direct bond, and R_{hy} is hydrophobic and comprises a linear or branched alkyl, cycloalkyl, aryl, alkaryl or alkoxylated derivative thereof;
B is derived from polymerizing an ethylenically unsaturated carboxylic acid monomer and/or its salts; and
C is optional and is derived from polymerizing an ethylenically unsaturated sulfonic acid monomer or phosphonic acid monomer and/or its salts, and x is the mole percent of A and is from about 5 to 80%, z is the mole % of C and is from about 0 to 25%, and y is the mole % of B, which is from about 1 to 95 mole %.

18. The aqueous herbicide solution of claim 17, wherein the water soluble herbicide is a water soluble salt of aryloxyalkanoic acid, a water soluble salt of a pyridyloxyalkanoic acid, a water soluble salt of glyphosate and mixtures or combinations thereof.

19. The aqueous herbicide solution of claim 17, wherein the aryloxyalkanoic acid is at least one of 2,4-D, 2,4-DB, dichlorprop, mecoprop, MCPA, or MCPB and the pyridyloxyalkanoic acid is triclopyr or fluroxypyr.

20. The aqueous herbicide solution of claim 17, wherein R_{hy} is a linear aryl moiety.

21. The aqueous herbicide solution of claim 17, wherein R_{hy} is naphthyl, ethoxylated naphthyl, phenyl, ethoxylated phenyl, benzyl, or ethoxylated benzyl.

22. The aqueous herbicide solution of claim 17, wherein the one or more fertilizers is ammonium sulfate, ammonium phosphate, ammonium nitrate or a mixture thereof.

23. The aqueous herbicide solution of claim 17, further comprising one or more inorganic cations selected from the group consisting of NH₄⁺, Na⁺, K⁺, ca²⁺, Mg²⁺, Fe²⁺, Fe³⁺, Cu²⁺, Mn²⁺, and Zn²⁺ or one or more organo ammonium cations selected from the group consisting of monomethyl ammonium, isopropyl ammonium, butyl ammonium, dimethyl ammonium, diethyl ammonium, triethyl ammonium, monoethanol ammonium, diethanol ammonium, dimethylethyl ammonium, diethylethanol ammonium, triethanol ammonium, triisopropanol ammonium, tetramethyl ammonium, tetraethyl ammonium, N,N,N-trimethylethanol ammonium (choline), and cations made from dimethylaminopropylamine and diethylenetriamine, or mixtures thereof.

24. The aqueous herbicide solution of claim 17, wherein the polymeric crystallization inhibitor is in the form of a salt.

25. The aqueous herbicide solution of claim 24, wherein the salt is an organic amine salt or an inorganic alkaline salt.

26. The aqueous herbicide solution of claim 24, wherein the salt contains an organo ammonium cation selected from monomethyl ammonium, isopropyl ammonium, butyl ammonium, dimethyl ammonium, diethyl ammonium, triethyl ammonium, monoethanol ammonium, diethanol ammonium, dimethylethyl ammonium, diethylethanol ammonium, triethanol ammonium, triisopropanol ammonium, tetramethyl ammonium, tetraethyl ammonium, N,N,N-trimethylethanol ammonium (choline), and cations made from dimethylaminopropylamine and diethylenetriamine, or mixtures thereof.

27. The aqueous herbicide solution of claim 17 that is a concentrate or a pre-mix concentrate.

28. The aqueous herbicide solution of claim 27, wherein the aqueous herbicide solution is a concentrate containing water soluble salts of 2,4-D and/or glyphosate.

29. The aqueous herbicide solution of claim 17 that is a spray solution.

30. The aqueous herbicide solution of claim 17, wherein the polymeric crystallization inhibitor is a co-polymer containing polyacrylate groups, polymethacrylate groups or polymaleate groups, or mixtures thereof.

31. The aqueous herbicide solution of claim 30, wherein the co-polymer containing polyacrylate groups comprises hydrophobically modified groups derived from the polymerization of an acrylate monomer and a styrene or substituted styrene monomer.

32. The aqueous herbicide solution of claim 17, wherein the polymeric crystallization inhibitor of structure I is comprised of, with respect to the total weight of I, 5 to 80 mole percent A, 0 to 25 mole percent C, the rest being B.

33. A dry herbicide composition comprising a water soluble salt of at least one herbicide, >16 wt % of one or more fertilizers, and one or more polymeric crystallization inhibitors of structure I
AₓB_{y}C_{z} I
wherein A is 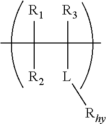
wherein R₁, R₂, and R₃ are independently H, CH₃, COOH, or CH₂COOH, L is a linking group comprising —C(══O)—O—, —C(══O)—N—, —CH₂—, —O—, —O—C(══O)—, or a direct bond, and R_{hy} is hydrophobic and comprises a linear or branched alkyl, cycloalkyl, aryl, alkaryl or alkoxylated derivative thereof;
B is derived from polymerizing an ethylenically unsaturated carboxylic acid monomer and/or its salts; and
C is optional and is derived from polymerizing an ethylenically unsaturated sulfonic acid monomer or phosphonic acid monomer and/or its salts, and x is the mole percent of A and is from about 5 to 80%, z is the mole % of C and is from about 0 to 25%, and y is the mole % of B, which is from about 1 to 95 mole %.

34. The dry herbicide composition of claim 33, wherein said herbicide is a water soluble salt of 2,4-D and/or a water soluble salt of glyphosate.

35. The dry herbicide composition of claim 33, wherein R_{hy} is a linear aryl moiety.

36. The dry herbicide composition of claim 33, wherein R_{hy} is naphthyl, ethoxylated naphthyl, phenyl, ethoxylated phenyl, benzyl, or ethoxylated benzyl.

37. The dry herbicide composition of claim 33, wherein the one or more fertilizers is ammonium sulfate.

38. The dry herbicide composition of claim 33, further comprising one or more inorganic cations selected from the group consisting of NH₄⁺, Na⁺, K⁺, ca²⁺, Mg²⁺, Fe²⁺, Fe³⁺, Cu²⁺, Mn²⁺, and Zn²⁺ or one or more organo ammonium cations selected from the group consisting of monomethyl ammonium, isopropyl ammonium, butyl ammonium, dimethyl ammonium, diethyl ammonium, triethyl ammonium, monoethanol ammonium, diethanol ammonium, dimethylethyl ammonium, diethylethanol ammonium, triethanol ammonium, triisopropanol ammonium, tetramethyl ammonium, tetraethyl ammonium and N,N,N-trimethylethanol ammonium (choline), and cations made from dimethylaminopropylamine and diethylenetriamine, or mixtures thereof.

39. The dry herbicide composition of claim 33, wherein the polymeric crystallization inhibitor is in the form of a salt.

40. The dry herbicide composition of claim 39, wherein the salt is an organic amine salt or an inorganic alkaline salt.

41. The dry herbicide composition of claim 33, wherein the salt contains an organo ammonium cation selected from monomethyl ammonium, isopropyl ammonium, butyl ammonium, dimethyl ammonium, diethyl ammonium, triethyl ammonium, monoethanol ammonium, diethanol ammonium, dimethylethyl ammonium, diethylethanol ammonium, triethanol ammonium, triisopropanol ammonium, tetramethyl ammonium, tetraethyl ammonium and N,N,N-trimethylethanol ammonium (choline), and cations made from dimethylaminopropylamine and diethylenetriamine, or mixtures thereof.

42. The dry herbicide composition of claim 33, wherein the polymeric crystallization inhibitor is a co-polymer containing polyacrylate groups, polymethacrylate groups or polymaleate groups, or mixtures thereof.

43. The dry herbicide composition of claim 42, wherein the co-polymer containing polyacrylate groups comprises hydrophobically modified groups derived from the polymerization of an acrylate monomer and a styrene or substituted styrene monomer.

44. The dry herbicide composition of claim 33, wherein the polymeric crystallization inhibitor of structure I is comprised of, with respect to the total weight of I, 5 to 80 mole percent A, 0 to 25 mole percent C, with the rest being B.
